(19) United States
(12) Patent Application Publication
(10) Pub. No.: US 2013/0080910 A1
(43) Pub. Date: Mar. 28, 2013

(54) DYNAMIC VISUALIZATION OF PAGE ELEMENT ACCESS RATES IN A WEB APPLICATION

(71) Applicants: Nicholas D. Bingell, Raleigh, NC (US); Erich P. Hoppe, Apex, NC (US); Andrew J. Ivory, Wake Forest, NC (US); David M. Stecher, Durham, NC (US)

(72) Inventors: Nicholas D. Bingell, Raleigh, NC (US); Erich P. Hoppe, Apex, NC (US); Andrew J. Ivory, Wake Forest, NC (US); David M. Stecher, Durham, NC (US)

(73) Assignee: INTERNATIONAL BUSINESS MACHINES CORPORATION, Armonk, NY (US)

(21) Appl. No.: 13/247,478

(22) Filed: Sep. 28, 2011

(51) Int. Cl. G06F 3/048

(52) U.S. Cl. 715/744

(57) ABSTRACT

Exemplary embodiments disclose dynamic visualizing an access rate of page elements in a web application for increased user viewablity and access. The example embodiments include in response to a server presenting the web application, monitoring by analytics software a set of accesses from user computers to the page elements to detect trends in usage patterns; visualizing the trends in the usage patterns by dynamically resizing the page elements based on the trends; arranging the resized page elements into a page element cloud; and outputting the modified layout of page elements for presentation to the user computers.

### BACKGROUND

Many, if not most, websites comprise one or more web applications, which are applications accessed over a network such as the Internet by user computers and displayed via a browser. Web applications use information resources or web documents written in a standard format such as HTML and/or XHTML. Each information resource, such as a webpage, may include any number of page elements, which are containers of graphical objects, e.g., hyperlinks.

A typical website may include many web applications and many page elements. For, example, a website may have hundreds of hyperlinks scattered on various different webpages. Visitors to a particular website navigate to the hyperlinks they wish to view and/or click on hyperlinks of interest. Through the monitoring of usage patterns of visitors to a website, the Web has become a major asset and marketing tool for many companies. The usage patterns enable the companies to find out what it is the consumer wants and/or is looking for, which in turn, allows the companies to learn how to tailor their products to meet consumer's needs.

Although capturing website metrics or analytics of usage patterns may be helpful to web administrators, many conventional web analytics tools are difficult to understand and/or produce visually unappealing results. For example, some analytics applications produce output in the form of statistics. Although the statistics may be presented in graph form, it is usually difficult and time consuming to plot analytics results so they can be easily understood.

Another type of tool for capturing metrics related to websites is a tag cloud (also known as a word or text cloud). A tag cloud is a visual representation of how frequently words or keyword metadata (tags) appear in websites or in free form text. Tags in a tag cloud are typically single words that are displayed in different font sizes or colors to indicate the relative frequency or importance of each tag. This format is used for quickly perceiving the most prominent terms.

Although a tags cloud can be useful in certain respects, they lack in terms of giving visitors to the website the ability to quickly scan the tag cloud to determine what elements of webpage or website are relevant to the user.

### BRIEF SUMMARY

Exemplary embodiments disclose dynamic visualizing an access rate of page elements in a web application for increased user viewablity and access. The example embodiments include in response to a server presenting the web application, monitoring by analytics software a set of accesses from user computers to the page elements to detect trends in usage patterns; visualizing the trends in the usage patterns by dynamically resizing the page elements based on the trends; arranging the resized page elements into a page element cloud; and outputting the modified layout of page elements for presentation to the user computers.

According to the method and system disclosed herein, the exemplary embodiments provide a page element cloud comprising selectable page elements, instead of text, that are sized according to their access rates by users. The page element cloud gives users the ability to find and easily access the most recent and/or popular items selected by users of a particular website.

### BRIEF DESCRIPTION OF SEVERAL VIEWS OF THE DRAWINGS

FIG. 1 is a logical block diagram illustrating an exemplary embodiment for a system that dynamically visualizes an access rate of page elements in a web application.

FIG. 2 is a flow diagram illustrating one embodiment of a process for dynamically visualizing an access rate of page elements in a web application.

FIG. 3 is diagram illustrating an example webpage showing how the exemplary embodiments may be used to visualize the access rate of page elements in a web application using a page element cloud.

### DETAILED DESCRIPTION

The exemplary embodiment relates to dynamically visualizing the access rate of page elements in a web application. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide methods and systems that dynamically visualize an access rate of page elements in a web application by arranging the page elements into a page element cloud that makes the most accessed page elements more prominent. Thus, the exemplary embodiments provide a page element cloud that comprises graphical page elements instead of text. In one embodiment, the page element cloud may be populated and dynamically changed depending on the most clicked page elements. As the rates users click on different page elements change, the page element cloud would reflect this. An image of the page element cloud could be displayed as a part of the website itself, and/or as part of the website's administrative console depending on the user's preferences. The algorithms used to resize the page may use frequency counts of how many times the page elements are accessed and then may normalize the size of the page elements relative to each other based on overall frequency of access.

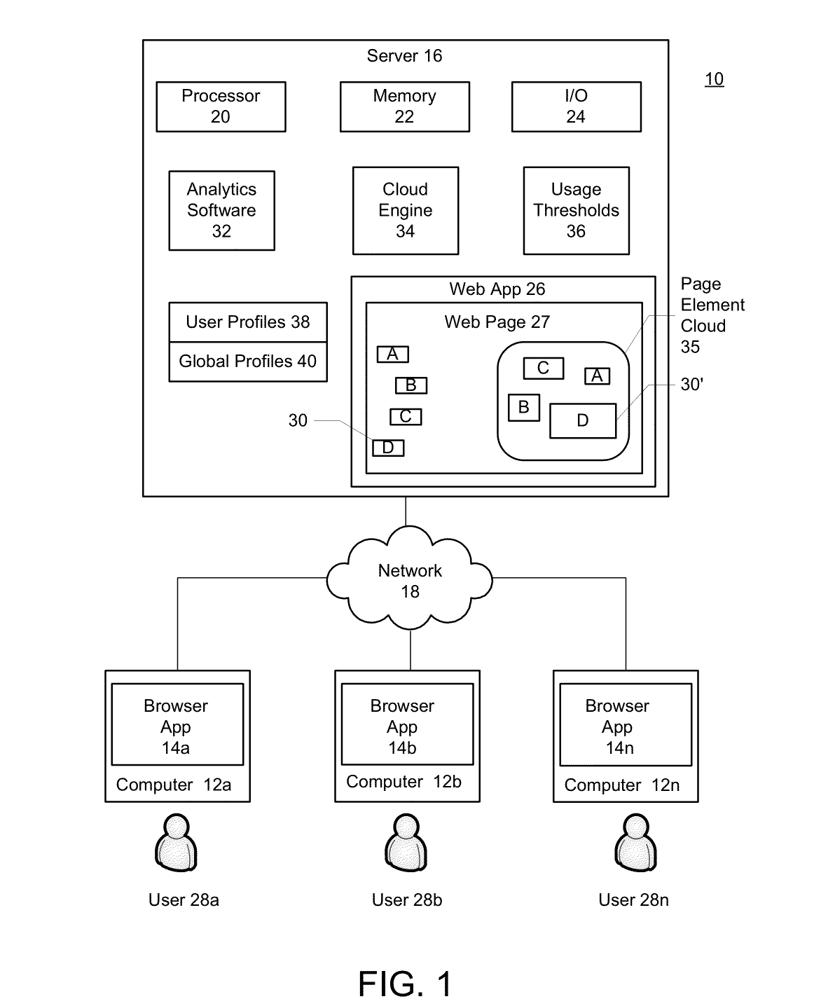

FIG. 1 is a logical block diagram illustrating an exemplary embodiment for a system that dynamically visualizes the access rate of page elements in a web application. The system 10 may include one or more computers 12a, 12b, 12n (collectively, computers 12) executing respective browser applications 14a, 14b, 14n (collectively, browser applications 14) and that communicate with a server 16 over network 18. The network 18 may be a public network, such as the Internet, or a private network (such as an intranet), a LAN, a WLAN, or a WMAX, or a combination of thereof. The server 16 may represent a single server or multiple servers, each having at least a processor 20, a memory 22, and an input/output (I/O) 24 coupled together via a system bus (not shown). In one embodiment, the server 16 may comprise a Web server, while in another embodiment the server 16 may comprise an application server.

The computers 12 may exist in various forms, including a personal computer (e.g., desktop, laptop, or notebook), a mobile phone, a personal digital assistant (PDA), a set-top box, a game system, and the like. Similar to the server 16, the computers 12 may include components of typical computing devices, such as processors, input devices (e.g., keyboard, pointing device, microphone for voice commands, buttons, touch screen, etc.), output devices (e.g., a display device). The server 16 and the computers 12 may further include computer-readable media, e.g., memory and storage devices (e.g., flash memory, hard drive, optical disk drive, magnetic disk drive, and the like) containing computer instructions that implement an embodiment of a dynamically reorganizing user interface of a web application when executed by the processor 20.

The processor 20 may be part of data processing system suitable for storing and/or executing software code including an operating system and various web applications 16. The processor 20 may be coupled directly or indirectly to elements of the memory 22 through a system bus (not shown). The memory elements can include local memory employed during actual execution of the program code, bulk storage, and cache memories which provide temporary storage of at least some program code in order to reduce the number of times code must be retrieved from bulk storage during execution.

The input/output 24 or I/O devices (including but not limited to keyboards, displays, pointing devices, etc.) can be coupled to the system either directly or through intervening I/O controllers. Network adapters (not shown) may also be coupled to the system to enable the data processing system to become coupled to other data processing systems or remote printers or storage devices through intervening private or public networks. Modems, cable modems and Ethernet cards are just a few of the currently available types of network adapters.

In operation, the server responds to different requests from the browser applications 14 executing on the computers 12 and presents, or serves, at least one web application 26 to the browser applications 14 for display to users 28a-28n (collectively referred to as users 28) of the computers 12.

As used herein, the web application 26 is an application that is accessed over a network such as the Internet or an intranet. In another embodiment, the web application may refer to a software application that is hosted in a browser-controlled environment (e.g., a Java applet) or coded in a browser-supported language (such as JavaScript, combined with a browser-rendered markup language like HTML) and reliant on a common web browser to render the application executable. Web applications use information resources or web documents that are written in a standard format such as HTML and/or XHTML, and supported by a variety of web browsers. Each information resource may include any number of page elements 30, where each page element 30 defines a container of one or more graphical objects.

As used herein, a page element 30 is any object in an information resource, such as a webpage, that a user may interact with. As such, a page element may also be referred to as user interface (UI) element. There are many different categories of page or UI elements that may appear on a webpage, including, but not limited to, hyperlinks, text entry fields, buttons, icons, images, navigation elements, and collapsible/expandable content (e.g., drop down menus and collapsible panels).

The users 28 of the computers 12 interact with the web application 26, e.g., by clicking the page elements 30 using pointing devices, such as a mouse or stylus. If a user's computer 12 is touch-screen enabled, the user 28 may also interact with web application 26 by touching a display screen of the computer 12 using a stylus or the user's finger.

The server 16 includes a component, referred to as analytics software 32, which is used to monitor a set of accesses from the user computers 12 to the page elements 30 comprising the web application 26 and to detect trends in the usage patterns. The analytics software 32 may be implemented as a standalone application or as a plug-in to the web application 26. One example of a commercially available analytics application is Analytics™ by Webtrends of Portland Oreg.

According to the exemplary embodiment, the server 16 further includes a cloud engine 34 that visualizes the detected trends in the usage patterns by dynamically resizing the page elements 30 based on the trends, and arranging the resized page elements 30′ into a page element cloud 35 based on the detected trends.

In one embodiment, the cloud engine 34 compares the detected usage patterns to a set of usage thresholds 36 to determine which page elements 30 have access rate changes sufficient for inclusion in the page element cloud. For example, assume in FIG. 1 that the analytics software 32 detects an increase in accesses to a link corresponding to the page element 30. If the cloud engine 34 determines that the number of total accesses to this page element 30 exceeds a predetermined number, and that rate increase exceeds a predetermined percentage, such as 5%, over predetermined amount of time, e.g., 3 minutes, then the cloud engine may dynamically reflect this change by resizing the page element 30 relative to the access rates of the other page elements. Assuming that page element 30 is the most accessed page element, then the cloud engine creates a resized page element 30′ that is more prominently displayed in the page element cloud 35. As the resized page element 30′ is actionable by the users 28, i.e., may be clicked while displayed in the page element cloud 35, the page element cloud 35 increases the ease of access to this commonly used page element.

In one embodiment, each of the users 28 may be presented with an option to enable the dynamic page element cloud feature for the web application 26, e.g., in response to a prompt from the web application 26. Enabling this feature allows the web application 26 to adjust and learn how best to display content based on the user's behavior. In one embodiment, user-configurable preferences may be set to enable a user profile 38 or a global profile 40, where the user profile 38 configures the cloud engine 34 to dynamically resize the page elements in the page element cloud 35 based on the individual user's usage patterns, and the global profile 40 configures the cloud engine 34 to dynamically resize the page elements based on the usage pattern of all user's 28.

Although the server 18 is shown as a single computer, it should be understood that the functions of server 18 may be distributed over more than one server. For example, the analytics software 32 and the cloud engine 34 may be implemented as a virtual entity whose functions are distributed over multiple servers. Although the analytics software 32 and the cloud engine 34 are shown as separate components, the functionality of each may be combined into a lesser or greater number of modules/components. In addition, although a server 12 is shown hosting the analytics software 32 and the cloud engine 34, the analytics software 32 and the cloud engine 34 may be run on any type of one more computers that have memory and processor.

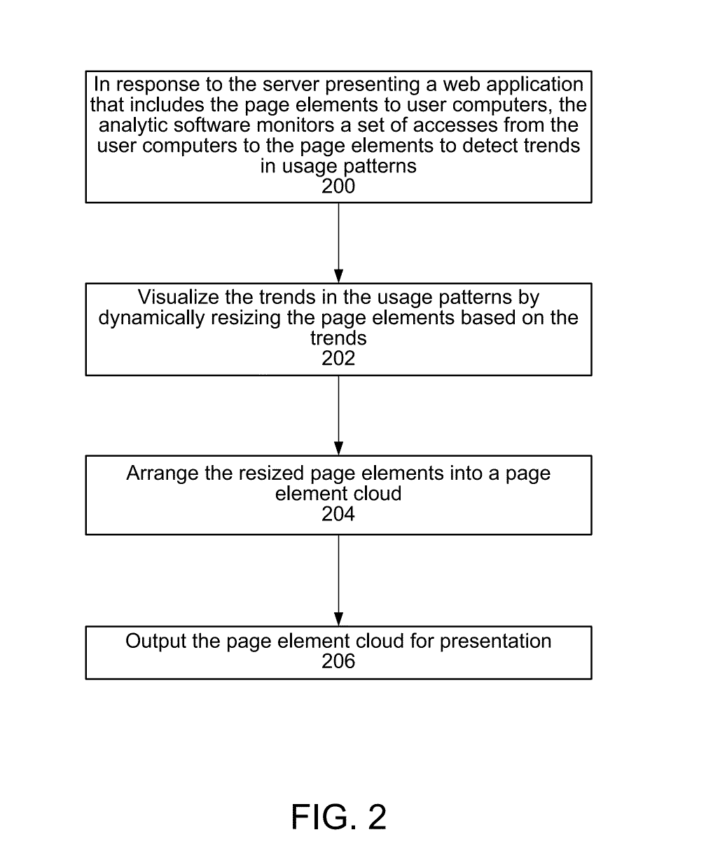

FIG. 2 is a flow diagram illustrating one embodiment of a process for dynamically visualizing an access rate of page elements in a web application. In one embodiment, in response to the server 16 presenting a web application 26 that includes the page elements 30, the analytics software monitors a set of accesses from user computers 12 to the page elements 30 to detect trends in usage patterns (block 200).

The analytics software 32 may be used to determine recent trends or long-term usage information in how the page elements 30 of the web application 26 were accessed by users 28. The analytics software 32 may store statistics of a number of hits (e.g., how many times a particular page element is clicked), pages views and unique visitors/users 28 the web application 26 receives overtime, for example, hourly, daily, weekly, monthly, and so on. In one embodiment, the analytics software 32 may be configured to detect trends in usage patterns for at least one of the following: all users 28 of the web application 26, a subset of all the users 28 of the web application 26, an individual user 28 of the web application 26, users 28 of the web application 26 associated with a social network, and a monitored condition.

The cloud engine 34 accesses the statistics compiled by the analytics software 32 and visualizes the trends in the usage patterns by dynamically resizing the page elements based on the trends, such as frequency of use (block 202), and arranging the resized page elements 30′ into a page element cloud (block 204).

In one embodiment, the cloud engine 34 may be configured to use any conventional algorithm that resizes graphical elements relative to each other within a defined area. As used herein, resizing the page elements includes increasing or decreasing a size of the at least one of the page elements proportionally relative to a total number of clicks for the web application 26 over a predetermined period of time. The cloud engine 34 may also normalize the size of the page elements relative to each other based on overall frequency of access. In another embodiment, visualizing the trends may further include modifying another visual characteristic of at least one of the page elements 30′, such as changing the color or highlighting one of the page elements as usage of the page element increases or decreases.

In another embodiment the arrangement of the page elements in the page element cloud 35 may include changing a location of at least one of the page elements 30′ relative to other page elements. For example, the position of at least one of the page elements 30′ may be moved towards a top of the page element cloud 35 as the usage of the at least one page element increases; and moving the position of the at least one of the page elements towards a bottom of the page element cloud 35 as the usage of the at least one of the page elements decreases.

In another embodiment, the cloud engine 34 may be configured to add or remove at least one of the page elements 30 to or from the information resource based on increased use or decreased use, respectively.

Accordingly, the cloud engine 34 may be configured to reposition the page elements relative to each other so that commonly used page elements are made more obvious and prominent in an information resource such as a webpage, thereby enhancing ease-of-access by the users 28.

According to the exemplary embodiments, a page element cloud 35 is created from any and all page elements in a given webpage and/or web application 26. The page element cloud provides users with a visual understanding of exactly what page elements are important by allowing users to identify, find, and access the most recent and/or popular items being selected. Not only may the page element cloud 35 decrease the amount of time one might spend searching or navigating the site, the page element cloud 35 may also increase the site's ease of use and attractiveness. The implementation of the page element cloud may help consumers gather required information with greater convenience and less frustration, allowing them to access items by simply clicking on an image within the page element cloud 35. Additionally, the page element cloud 35 gives administrators running the website an immediate visual breakdown of how the website is being used. This is useful for understanding exactly what elements are important as well as always having a graphic immediately ready for any sort of presentation on site usage.

As stated above, the cloud engine 34 compares statistical information regarding the detected usage patterns to a set of usage thresholds 36. For example, the software 32 may compile not only the number of hits for each page element and the total hits over time, but also a change percentage of access hits (e.g. a 30% access increase). The cloud engine 34 may include heuristics or rules that compare the number of hits for each page element, the total hits over time and/or the percentage change for a particular page element to one or more of the usage thresholds 36, and if the percentage change meets the usage thresholds 36, the size of the page element (and/or position of the page element in the page element cloud 35) may be adjusted in proportion to the number of hits or percentage change.

After the cloud engine 34 dynamically resizes the page elements and creates or modifies the page element cloud, the cloud engine 34 outputs the page element cloud 35 for presentation by the server 16 to the user computers 28 (block 206). In one embodiment, the cloud engine 34 may dynamically render the page element cloud 35 in real time for presentation by the server in response to requests. In an alternative embodiment, the page element cloud 35 may be stored and then accessed for presentation in response to a request.

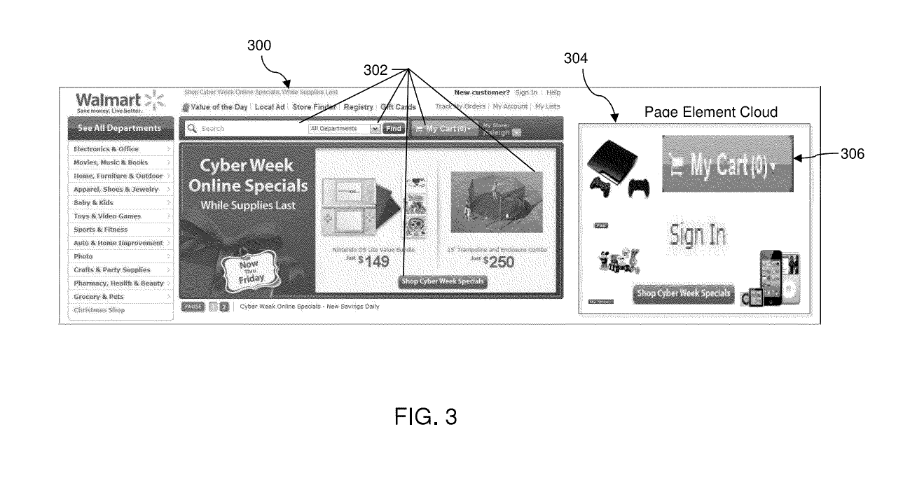

FIG. 3 is diagram illustrating an example webpage showing how the exemplary embodiments may be used to visualize the access rate of page elements in a web application using a page element cloud. FIG. 3 shows an example homepage 300 for Walmart that includes several page elements 302, including a shopping cart button and actionable images of products for purchase. According to the exemplary embodiment, the access (click) rates of the page elements 302 are tracked, and the most popular page elements are resized and added to the page element cloud 304 based on the access rates. The resized page elements 306 are sized in proportion to the other page elements 306 in the page element cloud 304, where the larger the page element 306, the higher the access rate.

In this example, assume that one of the more popular items being clicked on is for an image for the Sony PS3. Not as many people are clicking on stuffed animals for children so the page element for stuffed animals is displayed smaller than the image for the PS3. Additionally in this example, not many people have used the “find” button, but many people sign in, thus the “Sign In” button is also prominently displayed. Finally, everyone purchasing an item whether signed in or not must click on the “My Cart” button, the so the “My Cart” button appears very large in the page element cloud 304, reflecting its high rate of access and importance.

A method and system for dynamically visualizing an access rate of page elements in a web application has been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium that may include, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, partly on the user's computer and partly on a remote computer or entirely on the remote computer or server.

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A computer-implemented method for dynamically visualizing an access rate of page elements in a web application, comprising:
in response to a server presenting the web application, monitoring by analytics software a set of accesses from user computers to the page elements to detect trends in usage patterns;
visualizing the trends in the usage patterns by dynamically resizing the page elements based on the trends;
arranging the resized page elements into a page element cloud; and
outputting the page element cloud for presentation to one of the user computers and to an administration console.

2. The method of claim 1 further comprising detecting trends in usage patterns for at least one of: all users of the web application, a subset of all the users of the web application, an individual user of the web application, users of the web application associated with a social network, and a monitored condition.

3. The method of claim 1 wherein resizing the page elements further comprises increasing or decreasing a size of at least one of the page elements proportionally relative to a total number of clicks for the web application over a predetermined period of time.

4. The method of claim 1 wherein visualizing the trends further comprises modifying another visual characteristic of at least one of the page elements, including at least one of changing a color and highlighting.

5. The method of claim 1 wherein arranging the resized page elements into a page element cloud further includes moving a position of at least one of the page elements towards a top of the page element cloud as the usage of the at least one page element increases.

6. The method of claim 5, wherein arranging the resized page elements into a page element cloud further includes moving the position of the page elements towards a bottom of the page element cloud as the usage of the at least one of the page elements decreases.

7. The method of claim 1, further comprising providing user-configurable preferences to enable a user profile and a global profile, where the user profile configures a cloud engine to dynamically resize the page elements in the page element cloud based on an individual user's usage patterns, and the global profile configures the cloud engine to dynamically modify the page elements based on all user's usage patterns.

8. An executable software product stored on a computer-readable medium containing program instructions for visualizing an access rate of page elements in a web application, the program instructions for:
in response to a server presenting the web application, monitoring by analytics software a set of accesses from user computers to the page elements to detect trends in usage patterns;
visualizing the trends in the usage patterns by dynamically resizing the page elements based on the trends;
arranging the resized page elements into a page element cloud; and
outputting the page element cloud for presentation to one of the user computers and to an administration console.

9. The executable software product of claim 8, further comprising detecting trends in usage patterns for at least one of: all users of the web application, a subset of all the users of the web application, an individual user of the web application, users of the web application associated with a social network, and a monitored condition.

10. The executable software product of claim 8, wherein the instructions for resizing the page elements further comprises instructions for increasing or decreasing a size of at least one of the page elements proportionally relative to a total number of clicks for the web application over a predetermined period of time.

11. The executable software product of claim 8, wherein the instructions for visualizing the trends further comprises instructions for modifying another visual characteristic of at least one of the page elements, including at least one of changing the color and highlighting.

12. The executable software product of claim 8, wherein the instructions for arranging the resized page elements into a page element cloud further includes instructions for moving a position of at least one of the page elements towards a top of the page element cloud as the usage of the at least one page element increases.

13. The executable software product of claim 12, wherein the instructions for arranging the resized page elements into a page element cloud further includes instructions for moving the position of the page elements towards a bottom of the page element cloud as the usage of the at least one of the page elements decreases.

14. The executable software product of claim 8, further comprising providing user-configurable preferences to enable a user profile and a global profile, where the user profile configures a cloud engine to at least one of dynamically resize the page elements in the page element cloud based on an individual user's usage patterns, and the global profile configures the cloud engine to dynamically resize the page elements based on all user's usage patterns.

15. A server, comprising:
a memory;
a processor coupled to the memory; and
software components executed by the processor that are configured to:
in response to presentation of a web application comprising page elements, monitor a set of accesses from user computers to the page elements to detect trends in usage patterns;
visualize the trends in the usage patterns by dynamically resizing the page elements based on the trends;
arrange the resized page elements into a page element cloud; and
output the modified layout of page elements for presentation to the user computers.

16. The server of claim 15, wherein the software components are further configured to detect trends in usage patterns for at least one of: all users of the web application, a subset of all the users of the web application, an individual user of the web application, users of the web application associated with a social network, and a monitored condition.

17. The server of claim 15, wherein the page elements are resized by increasing or decreasing a size of at least one of the page elements proportionally relative to a total number of clicks for the web application over a predetermined period of time.

18. The server of claim 15, wherein the software components are further configured to modify another visual characteristic of at least one of the page elements, including at least one of changing a color and highlighting.

19. The server of claim 15, wherein the software components are further configured to move a position of at least one of the page elements towards a top of the page element cloud as the usage of the at least one page element increases.

20. The server of claim 19, wherein the software components are further configured to move the position of the page elements towards a bottom of the page element cloud as the usage of the at least one of the page elements decreases.

21. The server of claim 15, further comprising providing user-configurable preferences to enable a user profile and a global profile, where the user profile configures a cloud engine to dynamically resize the page elements in the page element cloud based on an individual user's usage patterns, and the global profile configures the cloud engine to dynamically modify the page elements based on all user's usage patterns.
